(19) United States
(12) Patent Application Publication
(10) Pub. No.: US 2007/0167327 A1
(43) Pub. Date: Jul. 19, 2007

(54) Biodegradable bag containing superabsorbent polymers

(76) Inventors: Milan H. Savich, Beaverton, OR (US); John D. Graham, Salem, OR (US)

Correspondence Address: STOEL RIVES LLP - SLC, 201 SOUTH MAIN STREET, ONE UTAH CENTER, SALT LAKE CITY, UT, 84111, US

(21) Appl. No.: 11/333,631

(22) Filed: Jan. 17, 2006

(51) Int. Cl. A01N 25/10; A01N 59/04

(52) U.S. Cl. 504/101; 504/361; 424/405

(57) ABSTRACT

An agricultural supplement delivery article for delivering superabsorbent polymer (“SAP”) particles is disclosed. The delivery article comprises a porous, biodegradable packet containing SAP particles. The biodegradable packet may optionally include additives, such as fertilizers, herbicides, pesticides, fungicides and/or other growth-promoting additives and nutrients.

### TECHNICAL FIELD

The present disclosure relates to superabsorbent polymer products and to methods and articles for applying and delivering superabsorbent polymer products in horticultural and agricultural applications.

### BRIEF DESCRIPTION OF THE DRAWINGS

The embodiments disclosed will become more fully apparent from the following description and appended claims, taken in conjunction with the accompanying drawings. Understanding that these drawings depict only typical embodiments and are, therefore, not to be considered limiting of the scope of the appended claims, the embodiments will be described with additional specificity and detail through use of the accompanying drawings in which:

FIG. 1 is a partially cut-away perspective view of one embodiment of an agricultural supplement packet containing superabsorbent polymer particles; and

FIG. 2 is a side elevation view of one embodiment of an agricultural supplement packet containing superabsorbent polymer particles planted adjacent the root system of a plant.

### DETAILED DESCRIPTION

Those skilled in the art will recognize that the methods, components and compositions disclosed herein may be arranged and practiced in a wide variety of different configurations, such as without one or more of the specific details described, or with other methods, components, materials, etc. In some cases, well-known materials, components or method steps are not shown or described in detail. Furthermore, the described components, method steps, compositions, etc., may be combined in any suitable manner in one or more embodiments.

Thus, the following more detailed description of various embodiments, as represented in the Figures, is not intended to limit the scope of the present disclosure, but is merely representative of certain exemplary embodiments. While the various aspects of the embodiments are presented in drawings, the drawings are not necessarily drawn to scale unless specifically indicated.

Superabsorbent polymers (“SAPs”) are materials that imbibe or absorb at least 10 times their own weight in aqueous fluid and that retain the imbibed or absorbed aqueous fluid under moderate pressure. The imbibed or absorbed aqueous fluid is taken into the molecular structure of the SAP rather then being contained in pores from which the fluid could be eliminated by squeezing. Some SAPs can absorb up to, or more than, 1,000 times their weight in aqueous fluid.

SAPs may be used in agricultural or horticultural applications. The terms “agricultural” and “horticultural” are used synonymously and interchangeably throughout the present disclosure. Applying SAPs to soil in an agricultural settings have resulted in earlier seed germination and/or blooming, decreased irrigation requirements, increased propagation, increased crop growth and production, decreased soil crusting, increased yield and decreased time of emergence.

Synthetic SAPs are commercially available and are conventionally used in conjunction with baby or adult diapers, catamenials, hospital bed pads, cable coating and the like. However synthetic SAPs may also be used in agricultural applications. Another type of SAP product used more widely in agricultural applications include starch graft copolymers. Starch graft copolymers comprise a monomer graft polymerized onto a polysaccharide, such as a starch or cellulose. Starch graft copolymers are typically used to absorb aqueous fluids for use in absorbent softgoods, in increasing the water holding capacity of soils, and as coatings onto seeds, fibers, clays, and the like.

One method of producing a starch graft copolymer SAP for use in agricultural applications involves graft polymerizing acrylonitrile onto a starch in the presence of an initiator, such as a ceric (+4) salt, to form the starch graft copolymer, and saponifying the nitrile groups with an alkali metal to form a saponificate having alkali carboxylate and carboxamide groups.

Another method comprises (1) graft polymerizing a monomer, other than acrylonitrile, onto a starch in the presence of an initiator to form a starch graft copolymer; (2) cross-linking the starch graft copolymer, for example, by adding a cross-linking agent to cross-link the starch graft copolymer; (3) adjusting the pH of the cross-linked starch graft copolymer, e.g., neutralization; (4) isolating the cross-linked starch graft copolymer; and (5) drying the cross-linked starch graft copolymer.

Exemplary polysaccharides include cellulose, starches, flours, and meals. Exemplary starches include native starches (e.g., corn starch (Pure Food Powder, manufactured by A. E. Staley), waxy maize starch (Waxy 7350, manufactured by A. E. Staley), wheat starch (Midsol 50, manufactured by Midwest Grain Products), potato starch (Avebe, manufactured by A. E. Staley)), dextrin starches (e.g., Stadex 9, manufactured by A. E. Staley), dextran starches (e.g., Grade 2P, manufactured by Pharmachem Corp.), corn meal, peeled yucca root, unpeeled yucca root, oat flour, banana flour, and tapioca flour. The starch may be gelatinized to provide optimal absorbency. An exemplary starch is gelatinized cornstarch. Furthermore, according to one embodiment, the weight ratio of the starch to the monomer is in the range of between about 1:1 and about 1:6.

Exemplary initiators for graft polymerizing a monomer onto a starch include cerium (+4) salts, such as ceric ammonium nitrate; ammonium persulfate; sodium persulfate; potassium persulfate; ferrous peroxide; ferrous ammonium sulfate-hydrogen peroxide; L-ascorbic acid; and potassium permanganate-ascorbic acid. Other suitable initiators known to those skilled in the art may be used, such as alternative persulfates and peroxides, as well as vanadium, manganese, etc. The amount of initiator used may vary based on the chosen initiator, the selected monomer, and the chosen starch. Some initiators, e.g., persulfates, may require the presence of heat. The initiator may be added in a single or multiple steps, and multiple initiators may be used.

Exemplary cross-linking agents include: glycerides; diepoxides; diglycidyls; cyclohexadiamide; methylene bis-acrylamide; bis-hydroxyalkylamides, such as bis-hydroxypropyl adipamide; formaldehydes, such as urea-formaldehyde and melamine-formaldehyde resins; isocyanates including di- or tri-isocyanates; epoxy resins, typically in the presence of a base catalyst; and derivatives and mixtures thereof

According to the first exemplary method where acrylonitrile is graft polymerized onto a starch, the resulting starch graft copolymer may be saponified with an alkali metal, such as potassium hydroxide or sodium hydroxide, to convert the nitrile groups into a mixture of carboxamides and alkali carboxylates. The starch graft copolymer may then be precipitated.

In one embodiment, precipitation occurs via an acid titration. Acid, such as hydrochloric acid, nitric acid, sulfuric acid, or phosphoric acid may be added until a pH of between about 2.0 and about 3.5, more particularly about 3.0, is reached. The resulting precipitate may be washed with water to remove the salts, and if necessary, separated in some manner. Separating methods include settling, centrifuging, and other mechanical means of separating.

The carboxylic acid of the starch graft copolymer may then be titrated back to the alkali form with the hydroxide of an alkali metal, such as potassium hydroxide, to a pH of between about 6.0 and about 8.0, more particularly about 7.0. This viscous mass may then be forced through a die plate, dusted to remove tackiness, and air or oven dried. The dried particles are then screened to the appropriate size. If desired, the particles could be ground to fine particles then formed into pellets of the desired size for use in agriculture.

In another embodiment, the isolated product is recovered from the viscous saponificate with the use of water miscible solvents such as alcohols. These include, for example, methanol, ethanol, propanol and isopropanol. The resulting dough is immersed into the alcohol, and the alkali starch graft copolymer is precipitated into particles that are optionally screened after drying to the desired size.

Formation of the starch-containing graft copolymers into particles of the desired size for direct use in agricultural equipment may be achieved by converting the viscous mass of alkali starch-graft copolymers into, for example, rod-shaped forms and drying the forms to the desired particle size. Selecting an appropriate die can vary the rod-shaped forms. A plate may be used that has been drilled or formed to contain holes of a particular size and shape. For example, the diameter of the rods may be controlled by the diameter of the holes drilled in the end plate. In one embodiment, the holes in the end plate may range from between about 1/16 inch to about ¼ inch in diameter. Rod-shaped forms may be lightly coated, after the die, to reduce their tackiness. Clays, starches, flours and cellulose may be used to dust the rods. In another embodiment, the starch graft copolymer may be isolated through the use of an extruder, such as through a heated screw.

According to another method of producing a SAP product, alternative monomers other than acrylonitrile are graft polymerized onto a starch in the presence of an initiator to form a starch graft copolymer. Exemplary alternative monomers include acrylic acid or methacrylic acid. Exemplary monomers may also include acrylamide or methacrylamide. Sulfonic acids, such as 2-acrylamido-2-methyl-propanesulfonic acid (AMPS) and vinyl sulfonic acid may also be used. Moreover, acrylates, such as ethyl acrylate and potassium acrylate may also be used. Derivatives and mixtures of the above-listed monomers may also be desirable.

In applications using acrylic acid, the addition of acrylamide thereto helps induce graft polymerization and adds to absorbency of the SAP. By way of example, the ratio by weight of acrylic acid to acrylamide may be about 2:1. Alternatively, the ratio of acrylic acid to acrylamide may also range up to a ratio of 9:1 and beyond. Because acrylamide is considered a neurotoxin, it may be desirable to reduce the relative amount of acrylamide to acrylic acid, while using enough to help induce graft polymerization of acrylic acid.

In alternative applications, acrylic acid may graft polymerize onto a starch or other polysaccharide without the assistance of acrylamide. For example, acrylic acid may polymerize when placed under heat and/or pressure. Polymerization without the addition of acrylamide may be accomplished, for example, in a heated screw extruder, such as a single screw or a double screw.

As described above, the monomer is graft polymerized onto a polysaccharide in the presence of an initiator to form a starch graft copolymer. Exemplary starches and initiators have been described above. The starch graft copolymer may then be cross-linked, for example, by adding a chemical cross-linking agent to form a cross-linked starch graft copolymer. It may be desirable for the starch graft copolymer to be cross-linked if it dissolves in aqueous fluids previous to being cross-linked. Cross-linking is one method to permit the starch graft copolymer to absorb aqueous fluids without dissolving. However, the amount of cross-linking agent added is typically indirectly proportional to the absorbency of the resulting SAP product. Exemplary cross-linking agents have also been described above.

Alternative methods of cross-linking may also be employed. For example, a solid SAP product may be cross-linked through irradiation, such as through exposure to gamma or x-ray electromagnetic radiation, or to an electron beam and the like. Irradiation facilitates cross-linking of the starch graft copolymer by creating free radicals in the copolymer chain. In some applications, after irradiation an annealing or melting process may be used to re-form the cross-linked copolymer chains. Furthermore, it may be desirable to perform the irradiation process in an atmosphere relatively free of oxygen.

Although the addition of cross-linking agents may be desirable in the production of SAPs, self-cross-linking copolymers may also be used. In a self-cross-linking copolymer, either a single self-reactive functional group or multiple self-reactive functional groups or multiple co-reactive functional groups are incorporated into the mixture. One exemplary co-reactive functional group is a copolymer of acrylic acid and glycidyl methacrylate.

The pH of the cross-linked starch graft copolymer may be adjusted to a desired value for the particular agricultural application. For example, the cross-linked starch graft copolymer may be neutralized to convert the carboxyl groups to potassium salts. Alternative pH values may be desirable depending upon the type of soil and the type of crop the resulting SAPs will be applied to. The resulting pH for most agricultural applications typically will range from about 6.0 to about 8.0. The desired pH may be greater or less than this range depending on the requirements for the particular agricultural application.

Alternatively, in some embodiments, pH adjustment of the starch graft copolymer may occur prior to cross-linking. Exemplary solvents that may be used to effect pH adjustment include potassium hydroxide, potassium methoxide, or a mixture thereof, any of which may optionally be diluted in methanol or other solvents.

In alternative embodiments, pH adjustment may not be necessary. For instance, if potassium acrylate were used as the monomer in lieu of acrylic acid, the resulting product may already be within an acceptable pH range.

The resulting pH-adjusted, cross-linked starch graft copolymer may then be isolated. One exemplary method of isolation involves simply drying the cross-linked starch graft copolymer, such as, for example, on a heated drum or via air-drying. The dried SAP product may then be pelletized according to pelletization methods known to those having skill in the art. According to this embodiment, isolation of the SAP product may be achieved in an alcohol-free environment.

In another embodiment, the step of isolating the starch graft copolymer involves extruding the cross-linked starch graft copolymer such as through a heated screw to form granules of SAP product. To minimize re-agglomeration of the granules, the granules may be coated with a dusting agent that decreases their propensity to stick together. Exemplary dusting agents include cellulose, clay, starch, flour, and other natural or synthetic polymers that prevent the granules from sticking together. Alternatively, the granules may be lightly sprayed with methanol to prevent them from sticking together, and/or the extrusion can be performed under high pressure.

Yet another exemplary method of isolating the starch graft copolymer involves precipitating the pH-adjusted, cross-linked starch graft copolymer using water-miscible solvents such as alcohols, e.g., methanol, ethanol, propanol, and isopropanol. Immersing the cross-linked starch graft copolymer in alcohol may cause the alkali starch graft copolymer to precipitate into particles that are later screened to the desired size after drying. The alcohol removes the water and extraneous salts from the cross-linked starch graft copolymer.

Another exemplary implementation of this method of precipitation involves blending sufficient methanol into the pH-adjusted, cross-linked starch graft copolymer to achieve a smooth dispersion. The smooth dispersion may then be pumped into a precipitation tank, which may include a stirring system that can vigorously mix the methanol while pumping in the smooth cross-linked starch graft copolymer dispersion. Once mixed, the resulting methanol and cross-linked starch graft copolymer particles may be collected by decanting or washing with methanol or centrifuged and collected, then dried to a moisture level of between about 1 percent and about 20 percent.

Another implementation of the isolation step through precipitation with methanol involves wetting the surface of the cross-linked starch graft copolymer with a small amount of methanol and then chopping the cross-linked starch graft copolymer into larger “chunks” that will not re-adhere to one another. Once the surface of the starch graft copolymer has been wetted with methanol, the resulting material is slippery to the touch and is no longer sticky. This effect may be achieved by using a compositional ratio of between about one part and about two parts of methanol per one part of solid.

Once the methanol has been added, the cross-linked starch graft copolymer may be pumped through an in-line chopper to form chunks having a diameter of less than one inch or, alternatively, hand-chopped with scissors. In one embodiment, the resulting mixture is then fed into a tank or Waring blender that has between about 1.5 gallons and about 4.0 gallons of additional methanol per pound of cross-linked starch graft copolymer. In some embodiments, the cross-linked starch graft copolymer may be subject to a pulverizer, in the presence of methanol, such as an in-line mixer or disintegrator which breaks the mass into smaller pieces as desired for the particular application. The methanol in the larger tank may be agitated with a Cowles dissolver or other mixer capable of achieving high speeds.

Yet another implementation of the isolation step through precipitation with methanol involves pre-forming the particle size before the methanol precipitation step. The use of dies to form strands or rods having different shapes and diameters can improve the particle size formation process. This particular implementation offers enhanced control of the final particle size. The cross-linked starch graft copolymer (neutralized or unneutralized) may be forced through a die plate having holes of varying diameter (e.g., about 1/16 inch to more than ¼ inch) and varying shapes (e.g., round, star, ribbon, etc.).

Methods of forcing the cross-linked starch graft copolymer through the die plate include using a hand-operated plunger, screw-feeding, auguring, pumping, and any other commonly known method. The resulting strands or rods may be placed into the precipitation tank without any further addition of methanol as a premixing agent. The strands or rods may be treated to prevent them from sticking together by, for example, wetting or spraying the strands or rods with methanol or dusting them with a dusting agent, such as, for example, cellulose, clay, starch, flour, or other natural or synthetic polymers. The resulting strands or rods may be precipitated with agitated methanol, removed from the tank, and dried.

Alternatively, the cross-linked starch graft copolymer product may be mixed with a solvent, such as water, to form a slurry or gel.

Depending on the agricultural application, the final SAP product may have a particle size that is courser than about 300 mesh. For example, in some applications where the starch graft copolymer is applied directly into the soil with the crop, the particle size is courser than about 50 mesh, such as between about 8 to about 25 mesh. This particle size range correlates to commercially available granule applicators. Therefore, alternative particle sizes may be used.

Finer particle sizes are typically used in seed coating or root dipping applications. By way of example, the particle size for seed coating may be between about 75 and about 300 mesh, such as about 100 mesh. For root coating, the particle size may be between about 30 mesh and about 100 mesh, such as about 50 mesh.

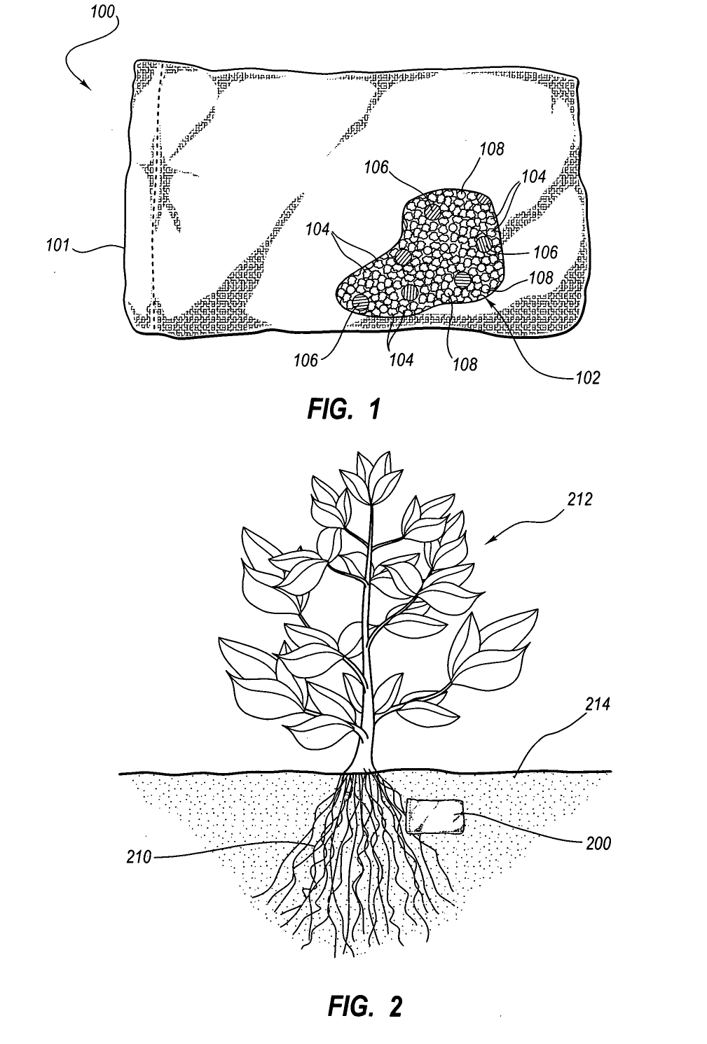

FIG. 1 represents one embodiment of an agricultural supplement packet 100, as shown from a partially cut-away perspective view. For purposes of this application, the term “packet” refers to any form of receptacle for containing material such as a bag, envelope, carton, container, etc. The packet 100 may be constructed of a biodegradable material 101, such as cellulose, that degrades and/or dissolves over time when planted in an agricultural setting. According to one embodiment, the supplement packet 100 may be constructed of material 101 that is similar to a conventional tea-bag. Other biodegradable materials may be used as would be apparent to those having skill in the art. Exemplary commercially available bags 100 may be available from manufacturers, such as Reforestation Technologies, Inc.

The packet 100 may be comprised of a single sheet of biodegradable material 101 that is sealed on all sides. Alternatively, the packet 100 may form a receptacle through a series of folds. Adhesives, fasteners, ties and the like may also be used to encapsulate a supplement matrix 102 within the packet 100 as would be apparent to one having skill in the art. In one embodiment the biodegradable material 101 of the packet 100 is porous, allowing fluid to diffuse through the walls of the packet 100.

The matrix 102 contained within the biodegradable packet 100 includes SAP particles 104, such as the synthetic and starch graft copolymers disclosed herein. The SAP particles 104 may be any size or form as would be apparent to those having skill in the art with the aid of the present disclosure. For example, the SAP particles 104 may be in granular form, or alternatively, powder, flake, pelletized or rod-shaped SAP products may also be used. By way of example, pelletized SAPs may be formed through a pelletization process or an extruding process and may optionally include an additive in the pellet, such as fertilizer.

The biodegradable packet 100 holds the SAP particles 104 in a defined location for a particular amount of time before the packet 100 degrades. When planted adjacent the actual or anticipated root system of a plant, the packet 100 localizes the SAP particles 104 adjacent the root zone. The packet 100 also may help to prevent the loss of SAP particles 104 during application and/or in runoff conditions such as heavy rainfall and the like.

In embodiments having a packet 100 formed of porous material 101, the packet 100 allows water or other fluids to interact with the hydrophilic SAP product 104 and to thereby form a gelatinous body of SAP product 104 within the packet 100. Because the packet 100 is biodegradable, the packet 100 degrades over time, permitting release of the SAP product 104 into the root zone. The biodegradable nature of the packet 100 also does not require the removal of the bag from its planted location.

Additional additives may be introduced into the matrix 102 of the biodegradable packet 100. Any additive to promote plant growth may be included in the matrix 102 as would be apparent to those having skill in the art with the aid of the present disclosure. For example, one exemplary additive includes fertilizers 106. Various fertilizers 106 that are commercially available may be included as would be apparent to those having skill in the art. In some embodiments, controlled-release fertilizers may be used. Alternative or additional additives 108 that may also be included within the matrix 102 of the packet 100 may include pesticides, herbicides, fungicides, growth hormones and regulators, mycorrhizal fungi, kelp products, soil-based nutrients and the like.

Exemplary pesticides that may be included in the agricultural supplement packet 100 include, but are not limited to, acaricides, algicides, antifeedants, avicides, bactericides, bird repellents, chemosterilants, herbicide safeners, insect attractants, insect repellents, insecticides, mammal repellents, mating disruptors, molluscicides, nematicides, plant activators, plant-growth regulators, rodenticides, synergists, and virucides. Exemplary microbial pesticides include bacillus thuringiensis and mycorrhizal fungi. Exemplary insecticides include, but are not limited to, thiodan, diazinon, and malathion.

Exemplary commercially available pesticides include, but are not limited to: Admire™ (imidacloprid) manufactured by Bayer, Regent™ (fipronil) manufactured by BASF, Dursban™ (chlorpyrifos) manufactured by Dow, Cruiserυ (thiamethoxam) manufactured by Syngenta, Karate™ (lambda-cyhalothrin) manufactured by Syngenta, and Decis™ (deltamethrin) manufactured by Bayer. A combination or blend of pesticides may also be used. Alternative pesticides may also be used as would be apparent to those having skill in the art.

Fungicides may also be included in the matrix 102 of the agricultural supplement packet 100. Fungicides may help control or prevent the growth of mold or fungus on the roots, seeds or seedlings thus inhibiting root or seed rot. Exemplary commercially available fungicides include, but are not limited to: Amistar™ (azoxystrobin) manufactured by Syngenta, Folicur™ (tebuconazole) manufactured by Bayer, Opus™ (epoxiconazole) manufactured by BASF, Dithane™ (mancozeb) manufactured by Dow, Flint™ (trifloxystrobin) manufactured by Bayer, and Ridomil™ (metalaxyl) manufactured by Syngenta. A combination or blend of fungicides may also be used. Alternative fungicides may also be used as would be apparent to those having skill in the art.

Regarding pesticides and fungicides, starch-based polymer SAP encapsulated pesticides or fungicides may imbibe water and swell such that the pesticide particles diffuse out of the starch matrix into the soil surrounding a plant, root, seed, or seedling in a controlled manner. Two exemplary goals of controlled-release pesticides or fungicides are (1) to increase efficacy of the pesticide/fungicide and (2) to reduce negative environmental consequences of pesticide/fungicide application.

Exemplary commercially available herbicides that may be included within the matrix 102 of the agricultural supplement packet 100 include, but are not limited to: Roundup™ (glyphosate) manufactured by Monsanto, Gramoxone™ (paraquat) manufactured by Syngenta, HarneSS™ (acetochlor) manufactured by Monsanto, Prowl™ (pendimethalin) manufactured by BASF, Dual™ (metolachlor) manufactured by Syngenta, and Puma™ (fenoxaprop) manufactured by Bayer. Furthermore, a combination or blend of herbicides may be used. Alternative herbicides may also be used as would be apparent to those having skill in the art.

Exemplary commercially available plant-growth regulators that may be optionally included in the matrix 102 of the agricultural supplement packet 100 include, but are not limited to: Ethrel™ (ethephon) manufactured by Bayer, PiX™ (mepiquat) manufactured by BASF, Dropp™ (thidiazuron) manufactured by Bayer, Finish™ (cyclanilide) manufactured by Bayer, and Royal MH™ (maleic hydrazide) manufactured by Crompton. A combination or blend of growth regulators may be used. Furthermore, growth inhibitors, growth retardants, growth stimulants, and derivatives and mixtures thereof may be included. Alternative growth regulators or hormones may also be used as would be apparent to those having skill in the art.

Exemplary soil-based nutrients that may be optionally included in the matrix 102 of the agricultural supplement packet 100 include calcium, magnesium, potassium, phosphorus, boron, zinc, manganese, copper, iron, sulfur, nitrogen, molybdenum, silicon, ammonium phosphate, fish meal, organic compounds and additives, organic based fertilizers derived from plant and animal products and derivatives, blends, and mixtures thereof. More information about exemplary growth-promoting additives can be found in The Farm Chemicals Handbook published by Meister Publishing Company.

The SAP particles 104 within the agricultural supplement packet 100 promote growth of the seed, seedling or plant adjacent to where the packet 100 is applied, as well as facilitate a more efficient uptake of nutrients, etc. Plant growth is facilitated by promoting the availability of beneficial nutrients to the plant, root, seed, or seedling. The high absorptivity of the SAP particles 104 facilitates entrapment of the fertilizers 106 and other additives 108 heretofore described, thereby minimizing or eliminating disassociation or release of the additive 108 from the SAP matrix due to heavy rainfall, watering, etc. Because some amount of the additive 108 will become entrapped in the matrix of the SAP product 104, the runoff rate of additives 108 is significantly less than the runoff rate of additives applied directly to soil, plants, roots, seedlings, or seeds.

Agricultural supplement packet 100 sizes may vary. An exemplary agricultural supplement packet 100 contains between about 1 and about 100 grams or larger of matrix 102 material. Alternatively, an exemplary supplement packet 100 contains between about 5 and about 100 grams of SAP particles 104 and additives 108. Alternatively, a supplement packet 100 contains between about 10 and about 50 grams of matrix 102 material.

FIG. 2 represents one embodiment of an agricultural supplement packet 200 containing superabsorbent polymer particles planted adjacent the root system 210 of a plant 212, as shown from a side elevation view. The supplement packet 200 may be planted adjacent the actual or anticipated root zone 210 of the plant 212. According to one exemplary method, the packet 200 is placed laterally of the root system 210 instead of above or below it. This method of planting the supplement packet 200 to a lateral side of the root system 210 may be desirable when the soil dynamics pull water and/or other nutrients transversely across the root hairs 210. However, the packet 200 may be placed in alternative locations, such as below the root system 210, as desired.

In one setting the supplement packet 200 may be planted adjacent an existing plant 212. In another setting the supplement packet 200 may be placed in a pot or hole into which a plant or seed may be planted. The soil 214 surrounding the plant 212 and packet 200 may be watered. Upon watering, the supplement packet 200 may dissolve or biodegrade such that its contents are in direct contact with the soil adjacent the root system 210. Additionally or alternatively, a liquid additive, such as liquid fertilizer, pesticide, herbicide, etc., may be delivered to plant 212 and packet 200 and become absorbed into the matrix of the SAP particles of the packet 200.

Application of the SAP-containing supplement packet 200 in proximity to a plant 212, root system 210, seed or seedling promotes the availability of beneficial nutrients and/or water to the plant 212, root 210, seed or seedling. Increasing the availability of nutrients and/or water may affect an increase in crop yield, growth rate, seed germination, and/or plant size, and may affect earlier seed germination and/or blooming, decreased irrigation requirements, increased propagation, increased crop growth, increased crop production, decreased soil crusting, increased root development, stronger/heartier plants, and plants less susceptible to disease.

It is believed that the movement from areas of high to lower concentrations is a mechanism by which nutrients are released from advanced polymer-coated controlled-release fertilizers. Including advanced polymer-coated fertilizer in the supplement packet 200 allows the nutrient solution to diffuse over time from the packet 200 to the root system 210. Aggressive root development may be promoted when feeding of transplants and adsorption of nutrients to nearby soil particles occurs.

Because the matrix of the agricultural supplement packet 200 is selected to maximize product performance in various settings, compositional parameters, such as solids concentration, concentration of starch, concentration of additives, types of additives, numbers of additives, addition processes, and addition timing, may vary greatly. Therefore, the following examples are intended to further illustrate exemplary embodiments, and are not intended to limit the scope of the disclosure.

### EXAMPLE 1

A porous, biodegradable bag including the following formulation:
Total nitrogen content: 14% (Nitrate: 5.88%; Ammoniacal: 8.12%)
Available phosphoric acid (P₂O₅): 14%
Soluble potash (K₂O): 14%
Sulfur (combined): 4.5%

### EXAMPLE 2

A biodegradable bag including the following blend of ingredients and having a total mass of 30 grams:
22% total nitrogen (coated slow-release nitrogen)
10% phosphoric acid (5% coated slow-release phosphate)
7% soluble potash (coated slow-release potash)
1.73% calcium
1.68% magnesium
1.60% combined sulfur
0.16% iron
0.24% manganese
0.06% zinc
0.01% copper
0.05% boron

The plant nutrients contained in the biodegradable bag in Example 2 were derived from homogenous polymer coated ammonium nitrate, ammonium phosphate, calcium phosphates, and potassium sulfate. The nitrogen, phosphorus and potassium sources have been coated to provide 12.6% coated slow-release nitrogen, 12.6% coated slow-release available P₂O₅, 2.6% slowly available soluble K₂), and 4.0% slow-release sulfur.

Use of porous, biodegradable bags including SAPs and additives have been shown to increase seedling growth from 250% to 400%, as well as to increase effective plant root systems from 50% to 100% over non-treated seedlings in the first three to five years. Also, use of the biodegradable bags increases plant and seedling survival and establishment in harsh conditions.

Depending on the type of packet used and the composition of additives within the bag, a single bag may fertilize an area for five years, making the porous, biodegradable bags a cost-effective means of fertilizing an area and improving plant growth. Furthermore, the use of the biodegradable packets or bags provide an additional benefit of its ease and convenience of use and application.

Moreover, the use of agricultural supplement packets described herein reduce the human exposure to the planting medium, including exposure to chemicals, the SAP product, the additives, and any dust derived therefrom. The efficiency and accuracy of applying SAP products and additives may be improved because the amount of SAP product and additive is pre-measured based on the desired application so human error and application time is minimized. The use of the supplement packets may also ensure the prolonged presence of the SAP product and prolonged delivery of the additive used in conjunction with the SAP product.

The supplement packet may also reduce the loss of SAP product and additive to the air (in the form of dust) that occurs in conventional, dry applications. The supplement packet also may reduce the loss of SAP product and additives through leaching. Moreover the packets also provide for a reduction in groundwater contamination, toxicity, odor, volatility, and decompositional problems compared to the application of fertilizers not entrapped in an SAP matrix and packet.

While specific embodiments and applications have been illustrated and described, it is to be understood that the present disclosure is not limited to the precise configuration and components disclosed herein. Various modifications, changes, and variations which will be apparent to those skilled in the art may be made in the arrangement, operation, and details of the components, compositions and methods disclosed herein without departing from the spirit and scope of the following claims.

What is claimed is:

1. An agricultural supplement delivery article, comprising:
a packet constructed of biodegradable material; and
an agricultural supplement matrix contained within the biodegradable packet;
wherein the agricultural supplement matrix includes superabsorbent polymer particles comprising monomers that are at least one of the following: acrylonitrile, acrylic acid, methacrylamide, 2-acrylamido-2-methyl-propanesulfonic acid, methacrylic acid, vinyl sulfonic acid, ethyl acrylate, potassium acrylate, and derivatives and mixtures thereof

2. The agricultural supplement delivery article of claim 1, wherein the biodegradable material is cellulose-based.

3. The agricultural supplement delivery article of claim 2, wherein the packet is porous.

4. The agricultural supplement delivery article of claim 1, wherein the superabsorbent polymer is a starch graft copolymer.

5. The agricultural supplement delivery article of claim 1, wherein the superabsorbent polymer is a synthetic polymer.

6. The agricultural supplement delivery article of claim 1, wherein the agricultural supplement matrix further comprises fertilizer.

7. The agricultural supplement delivery article of claim 1, wherein the agricultural supplement matrix further comprises pesticide.

8. The agricultural supplement delivery article of claim 1, wherein the agricultural supplement matrix further comprises herbicide.

9. The agricultural supplement delivery article of claim 1, wherein the agricultural supplement matrix further comprises fungicide.

10. The agricultural supplement delivery article of claim 1, wherein the agricultural supplement matrix further comprises growth regulators.

11. The agricultural supplement delivery article of claim 1, wherein the superabsorbent polymer particles comprise acrylonitrile monomers.

12. The agricultural supplement delivery article of claim 1, wherein the superabsorbent polymer particles comprise acrylic acid monomers.

13. The agricultural supplement delivery article of claim 12, wherein the superabsorbent polymer particles further comprise acrylamide monomers.

14. The agricultural supplement delivery article of claim 1, wherein the superabsorbent polymer particles are configured to release aqueous fluid over time.

15. The agricultural supplement delivery article of claim 14, wherein the superabsorbent polymer particles are configured to reduce the run-off rate of agricultural additives.

16. The agricultural supplement delivery article of claim 1, wherein the agricultural supplement matrix weighs between about 5 and about 100 grams.

17. An article for localizing superabsorbent polymers in agricultural applications, comprising:
a bag configured to biodegrade over time when planted adjacent a root zone of a plant; and
superabsorbent polymer particles contained within the biodegradable bag;
wherein the superabsorbent polymer is a starch graft copolymer.

18. The article of claim 17, further comprising an agricultural additive contained within the bag, wherein the agricultural additive is at least one of the following: fertilizer, pesticide, herbicide, fungicide, and growth regulators.

19. A method for delivering a superabsorbent polymer in agricultural applications, comprising:
obtaining a biodegradable bag containing superabsorbent polymer particles, the superabsorbent polymer comprising a starch graft copolymer; and
placing the biodegradable bag adjacent an actual or anticipated location of a root system of a plant.

20. The method of claim 19, wherein placing the biodegradable bag adjacent the root system comprises placing the biodegradable bag to a lateral side of the actual or anticipated location of the root system of the plant.

21. The method of claim 19, further comprising planting a plant, seed or seedling such that the biodegradable bag is positioned laterally of the actual or anticipated location of the root system of the plant, seed or seedling.

22. The method of claim 21, further comprising watering the plant, seed or seedling.

23. The method of claim 21, further comprising delivering a liquid additive to the plant, seed or seedling.

24. The method of claim 19, wherein the biodegradable bag further contains at least one of the following: fertilizer, pesticide, herbicide, fungicide, and growth regulators.
